(19) United States
(12) Patent Application Publication
(10) Pub. No.: US 2018/0345714 A1
(43) Pub. Date: Dec. 6, 2018

(54) Method of Manufacturing a Security Document

(71) Applicant: INNOVIA SECURITY PTY LTD, Craigieburn, Victoria (AU)

(72) Inventors: Karlo Jolic, Craigieburn (AU); Gary Fairless Power, Craigieburn (AU)

(73) Assignee: CCL SECURE PTY LTD, Craigieburn, Victoria (AU)

(21) Appl. No.: 16/061,985

(22) PCT Filed: Dec. 14, 2016
(86) PCT No.: PCT/AU2016/051227

§ 371 Date: Jun. 13, 2018

(30) Foreign Application Priority Data
Dec. 14, 2015 (AU) 2015101793

(51) Int. Cl. B42D 25/48; B42D 25/342; B42D 25/324; B42D 25/328; B41F 11/02

(52) U.S. Cl. CPC B42D 25/48; B42D 25/342; B42D 25/351; B42D 25/328; B41F 11/02; B42D 25/324

(57) ABSTRACT

A method of manufacturing a first security document, the security document including a first periodic array of image elements applied to a first surface of a transparent substrate and extending in a first direction; and a first periodic array of revealing elements applied to an opposing surface of the substrate and extending in a second direction, the first periodic array of revealing elements being superposed with the first periodic array of image elements, such that an optical variable effect can be observed between at least a first viewing angle and a second viewing angle. The method includes the steps of (a) determining one or more characteristics of moiré bands that would be or are observed to transition across the first periodic array of image elements during movement of the security document relative to an observer between, at least, the first viewing angle and the second viewing angle as a result of the first direction being different from the second direction; (b) constraining at least one dimension of the first periodic array of image elements and/or the first periodic array of revealing elements to be smaller than the width of at least one of the moiré bands; and (c). causing the first periodic array of image elements and the first periodic array of revealing elements, constrained as set out in step (b), to be manufactured as part of the security document.

### TECHNICAL FIELD

The invention relates generally to security documents in which security elements are used as an anti-counterfeiting measure, and in particular to the manufacture of such security documents.

### BACKGROUND OF INVENTION

It is known to provide optically variable devices in which an array of lenticular (part-cylindrical) lenses focuses on an object plane containing multiple sets of interleaved image elements. Each set of image elements (strips) belongs to a distinct image, so that a different image becomes visible as the viewing angle is changed. The effect produced by optically variable devices containing multiple sets of interleaved image elements is sometimes known as a “flipping image” effect. If a two-channel flipping image is to be produced, then two sets of interleaved image elements are required.

Lenticular lenses can be applied to a substrate by using a roll-to-roll lens embossing process. After this process has been completed, rolls of material including embossed lenses are then cut into rectangular sheets and sent to a banknote printer. Lenticular imagery designed to implement the flipping image effect is then applied to the reverse side of the lenticular lenses by the banknote printer, using a sheet-fed printing process. Finally, the printed sheets at the output of the banknote printer are cut into individual banknotes.

In a banknote manufactured in this way, an amount of lens-to-print skew is typically introduced. Because banknote sheets are very thin, the lenticular lenses that are used must be very small, which in turn results in any lens-to-print skew introduced during manufacture being far more critical than would be the case in conventional lenticular sheet-fed printing.

The lens-to-print skew introduced during manufacture can introduce a moiré fringe into the flipping image effect. In the case of a two-channel flipping image, under ideal conditions only one of the two images is viewed through the lenticular lens at a first viewing angle, and the other of the two images in viewed through the lenticular lens at another viewing angle. However, if a skew is introduced between the printed images and the lenticular lenses, a moiré pattern or fringe can result. In this case, rather than “hard” flip between the two images as the banknote is rotated, diagonal moiré bands roll across the viewed image revealing one image in the moiré band and the other image outside of the moiré band.

There is a need for a method of manufacturing a banknote or other security document that minimizes the impact of undesirable moiré fringes or patterns on the image or images projected by a security device forming part of that security documents.

### SUMMARY OF INVENTION

One aspect of the present invention provides a method of manufacturing a first security document, the security document including:

a transparent substrate;

a first periodic array of image elements applied to a first surface of the substrate and extending in a first direction; and

a first periodic array of revealing elements applied to an opposing surface of the substrate and extending in a second direction, the first periodic array of revealing elements being superposed with the image elements, such that an optical variable effect can be observed between at least a first viewing angle and a second viewing angle,

the method including the steps of:

a. determining one or more characteristics of moiré bands that would be or are observed to transition across the image elements during movement of the security document relative to an observer between, at least, the first viewing angle and the second viewing angle as a result of the first direction being different from the second direction;

b. constraining at least one dimension of the first periodic array of image elements and/or the first periodic array of revealing elements to be smaller than the width of at least one of the moiré bands; and

c. causing the first periodic array of image elements and the first periodic array of revealing elements, constrained as set out in set (b), to be manufactured as part of the security document.

Advantageously, by constraining the extent of the array of image elements and/or the array of revealing elements in this manner, one or more moiré bands will not appear on the magnified image elements during movement of the banknote or other security document between various viewing angles.

In one or more embodiments of the invention, one or more characteristics of moiré bands can be determined in step a by:

manufacturing a calibration security document including a second periodic array of revealing elements and a second periodic array of image elements, the second periodic array of revealing elements and the second periodic array of image elements being identical to the first periodic array of image elements and the second periodic array of image elements except that they extend over a sufficient area to enable moiré bands to be observed to transition across the image elements during the movement of the security document; and

measuring the one or more characteristics of the observed moiré bands.

In such embodiments, a test production run is effectively carried out using an array of image elements that are sufficiently large to ensure that one or more moiré bands transition across the magnified image elements as the security document is moved between the first and second viewing angles. Characteristics of the moiré bands, such as the moiré period, moiré half period, angular offset or skew of the moiré bands from the direction in which the array of image elements extends, and the width of the moiré band itself, can be analysed in order to design an array of image elements that have at least one dimension smaller than the width of at least one of the moiré bands.

In other embodiments of the invention, one or more characteristics of the moiré bands may be determined in step a by:

determining a maximum skew between the first periodic array of image elements and the first periodic array of revealing elements that may be introduced by one or more manufacturing steps during manufacture of the first security document; and

deriving the one or more characteristics of moiré bands from the maximum skew.

For example, a maximum lens-to-print skew can be determined by added the roll-to-roll lens embossing skew, sheeting skew, in-feed skew at a sheet-feed printer and/or printing distortion skew introduced by a security document printer, the maximum allowable size of one or more dimensions of the array of image elements then being derived from that total skew.

In one or more embodiments, the characteristics of moiré bands include any one or more of: the moiré period or other value representative of the width of the smallest moiré bands; and the moiré angle characterising the angular offset of the moiré bands from the first direction.

In one or more embodiments, the periodic array of revealing elements reveals a first image channel from the first viewing angle and a second image channel from the second viewing angle; and the or each periodic array of image elements includes a first group of image elements forming a first image viewable in the first image channel.

The or each periodic array of image elements may further include a second group of image elements forming a second image viewable in the second image channel.

In one or more embodiments, the first periodic array of revealing elements reveals a third image channel from a third viewing angle; and the or each periodic array of image elements includes a third group of image elements forming a third image viewable in the third image channel.

In one or more embodiments, the revealing elements are lens elements that act to magnify the image elements.

In one or more embodiments, the revealing elements are lines.

### Definitions

### Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. The diffraction gratings and optically variable devices described herein may also have application in other products, such as packaging.

### Security Device or Feature

As used herein the term security device or feature includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

### Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET), biaxially-oriented polypropylene (BOPP); or a composite material of two or more materials, such as a laminate of paper and at least one plastic material, or of two or more polymeric materials.

### Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

### Opacifying Layers

One or more opacifying layers may be applied to a transparent substrate to increase the opacity of the security document. An opacifying layer is such that L_{T}<L₀, where L₀ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

### BRIEF DESCRIPTION OF DRAWINGS

Embodiments of the invention will now be described with reference to the accompanying drawings. It is to be understood that the embodiments are given by way of illustration only and the invention is not limited by this illustration. In the drawings:

FIG. 1 is a cutaway side view of one embodiment of a security device, including a lenticular lens, substrate and imaging elements, for use in a security document;

FIG. 2 is a plan view of selected lens elements and image elements from the security device shown in FIG. 1;

FIG. 3 depicts two groups of image elements forming a separate image that can be observed when the security device shown in FIG. 1 is viewed from separate viewing angles;

FIG. 4 is a schematic representation of a first apparatus for use in the production of a security document including the security device shown in FIG. 1, and notably includes a lens embossing arrangement;

FIG. 5 is a cutaway side view of the partially manufactured security document produced by the apparatus of FIG. 4;

FIG. 6 is a plan view of a sheeting operation performed during manufacture of a security document including the security device shown in FIG. 1;

FIG. 7 is a schematic depiction of a sheet-feed printer used during manufacture of a security document including the security device shown in FIG. 1;

FIGS. 8 to 10 are graphical representations of the moiré pattern or fringes that can transition across the magnified image elements of the security device shown in FIG. 1 when observed by a user from various viewing angles;

FIGS. 11 and 12 respectively depict different images formed from groups of image elements and which are interleaved in the security device of FIG. 1;

FIG. 13 is a graphical representation of the transition of a moiré pattern or fringe across the magnified image elements observable by a user;

FIG. 14 is a graphical representation of characteristics of moiré bands used according to one or more embodiments of the invention to constrain the size of the image elements of the security device shown in FIG. 1;

FIG. 15 is a graphical representation or the application of those constraints to one or more dimensions of the imaging elements of the security device or FIG. 1;

FIG. 16 is a schematic representation of a security device including a periodic array of lens elements and 5 interleaved images each comprised of a series of image elements; and

FIG. 17 is a cutaway view of a further embodiment of a security device, including printed lines, substrate and image elements, for use in a security document.

### DETAILED DESCRIPTION

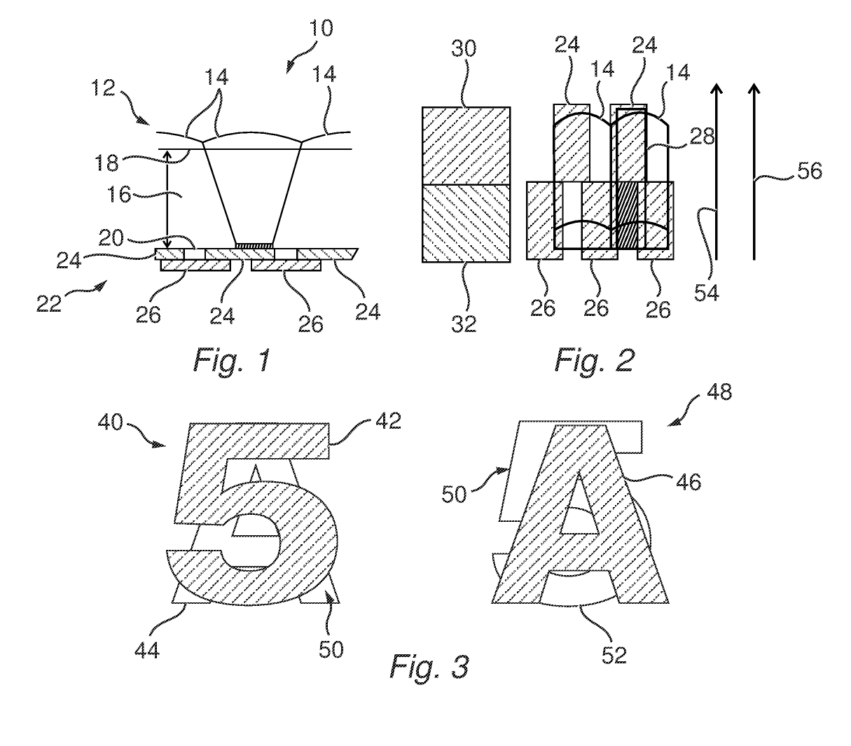

Referring to FIG. 1, there is shown one embodiment of a security device 10 forming part of a banknote or other security document. The security device 10 includes a periodic array 12 of lens elements 14. The device 10 further includes a substrate 16 having an upper surface 18 and a lower surface 20. The array 12 of lens elements 14 is applied to the upper surface 18, whilst the lower surface 20 is an object plane carrying a periodic array 22 of image elements. In this case, the periodic array 22 of image elements comprises a first group of elements 24 forming a first image interlaced with a second group of image elements 26 forming a second image.

The periodic array 12 of lens elements 14 and the periodic array 22 of image elements forms a lenticular imaging device, in which the lens elements are lenticular (part-cylindrical) lenses which are, at least partly, focusing on an object plane of multiple sets of interleaved image elements. Whilst the lenticular lenses in FIG. 1 are shown as being out of focus to some degree, as described in WO2010099571, in-focus lenses can also be used in the same context. The groups of image elements 24 are shown slightly offset from the group of image elements 26 in the cross sectional view of FIG. 1 for the purposes of clarity.

The left edges of neighbouring image elements 24 of the first group of image elements are aligned with the left edges of associated lens elements 14 through which the image elements 24 are to be viewed. The left hand edges of the image elements 26 of the second group of image elements are aligned with the optical axis associated with lens elements 14. Image elements 24 and 36 are in an interleaved relationship in the object plane 20 to form first and second channels of a flipping image.

In FIG. 2, the lens elements 14 have a focusing region 28 such that each lens elements 14 acts to magnify a portion or portions of one or more image elements within that focussing region. The exact positioning of the focussing region 28 with respect to the image elements 24, 26 in the object plan 20 will depend upon the viewing angle of a user. For example, from the viewing angle depicted in FIG. 2, the focussing region 28 overlaps one of the image elements 24 almost entirely, and only includes a very small portion of an imaging element 26. In this case, the image elements 24 of the first group of image elements should be visible to display the first channel of the flipping image, whilst the image elements 26 of the second group should not be seen. Accordingly, when viewed from the viewing angle shown in FIG. 2, the array of lens elements and array 22 of image elements produces an apparent intensity 30 of the image elements 24 but only produces a reduced intensity 32 for the image elements 26.

As shown in FIG. 3, the net impression to the viewer when viewed from the viewing angle shown in FIG. 2 is that of a first image 40 corresponding to a foreground region 42 in the form of the character “5” produced by the first group of image elements 24. Due to the presence of crosstalk from the second group of image elements 26 (that is, the reduced intensity image 32 produced from the small overlap of the focussing region 28 with the image elements 26) a shadow 44 of character “A” is seen in the background.

As the device is tilted, the character “A” becomes more prominent, due to a greater proportion of the width of the focussing region 28 overlapping the image elements 26, and the character “5” becomes gradually more muted, until the two characters “5” and “A” become indistinguishable. On further tilting, the character “A” 46 becomes a more prominent part of an image 48 with the crosstalk 50 from image elements 24 of character “5” forming the background 52.

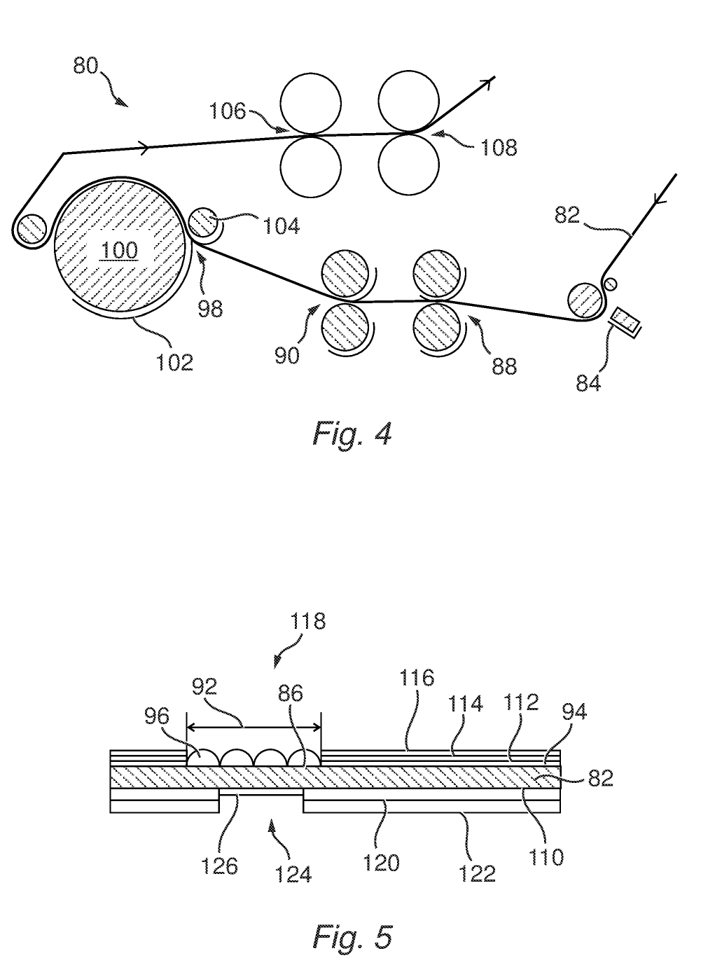

An exemplary apparatus 80 for in-line manufacturing part of a security document including the security device 10 shown in FIG. 1 is depicted in FIG. 4. A continuous web 82 of translucent or transparent material such as polypropylene or PET is subject to an adhesion promoting process at a first processing station 84 including a roller assembly. Suitable adhesion promoting processes are flame treatment, corona discharge treatment, plasma treatment or similar.

An adhesion promoting layer 86 is applied at a second processing station 88 including a roller assembly. A suitable adhesion promoting layer is one specifically adapted for the promotion of an adhesion of UV curable coatings to polymeric surfaces. The adhesion promoting layer may have a UV curing layer, a solvent-base layer, a water-based layer or any combination of these. Preferably, the adhesion promoting layer has a primer layer that includes a polyethylene ionine. The primer layer may also include a cross linker, for example a multi functionary isocyanate.

A third processing station 90, which also includes a roller assembly, the radiation sensitive coating is applied to the dried surface of the adhesion promoting layer 86. The radiation sensitive coating can be applied via flexographic printing, gravure printing or a silk screen printing process.

The radiation sensitive coating is only applied to the security element area 92 on a first surface 94 where a lens structure 96 including a period array of lens elements identical to the elements 14 depicted in FIG. 1 is to be positioned. The security element area 92 can take the form of a stripe, a discreet patch in the form of simple geometric shape or in the form of a more complex graphical design.

While the radiation sensitive coating is still liquid, it is processed to form the lens elements shown in FIG. 1 at a fourth processing station 98. In one embodiment, the processing station 98 includes an embossing roller 100 for embossing a security element structure, such as the lens structure 96 into a radiation sensitive coating in the form of a UV curable ink. The cylindrical embossing surface 102 has surface relief formations corresponding to the shape of the security element structure 96 to be formed. In one embodiment, the surface relief formations can orient the array of lens elements in the machine direction, transverse to the machine direction, or in multiple directions at an angle to the machine direction. Although the apparatus 80 can form micro lenses in a variety of shapes, in the embodiments described herein the lens elements form an array of lenticular lenses.

The cylindrical embossing surface 102 of the embossing roller 100 may have a repeating pattern of surface relief formations or the relief structure formations may be localized to individual shapes corresponding to the shape of the security elements area 92 on the substrate 82. The embossing roller 100 may have the surface relief formations formed by a diamond stylus of appropriate cross section, or the surface relief formations may be provided by at least one metal shim provide on the embossing roller 100. At least one metal shim may be attached via adhesive tape, magnetic tape, clamps or other appropriate mounting techniques.

The UV curable ink on the substrate is brought into intimate contact with the cylindrical embossing surface 102 of the embossing roller 100 by a UV roller 104 at processing station 98 such that the liquid UV curable ink flows into the surface relief formations of the cylindrical embossing surface 102. At this stage, the UV curable ink is exposed to UV radiation transmitted through the substrate layer 82. The UV radiation may be transmitted through the surface of the UV roller 104. The UV roller 104 preferably had internal UV lamps or a roller surface that is UV transparent in at least some areas.

With the security element structure 96 applied to the document substrate 82, one or more additional layers are applied at a downstream processing station including further roller assemblies 106 and 108. The additional layers may be clear or pigmented coatings and applied as a partial coating, as a contiguous coating or accommodation of both. In one preferred method, the additional layers are opacifying layers which are applied to one or both surfaces of the substrate 82 except in the region of the security element structure.

FIG. 5 shows a partially manufactured security document formed with an embossed security element structure 96 in the form of a lens structure 96 having an array of lens elements. These security document comprises a transparent substrate of polymeric material, preferably by axially oriented polypropylene (BOPP) having a first surface 94 and a second surface 110. Opacifying layers 112, 114 and 116 are applied to the first surface 94, except for a window area 118 where the security element structure 96 is applied to the first surface 94.

Opacifying layers 120 and 122 are applied to the second surface 110 except in a window area 124. The window area 124 substantially coincides with the window area 118 on the first surface 94. The window area 124 shown in FIG. 5 is smaller than the window are 118 although it will be appreciated the relative sizes and locations of the window areas 118 and 124 may be changes in other embodiments. A printed layer 126 may be applied to the second surface 110 on the opposite side of the substrate in the window area 124. The printed layer 126 may form an image or images viewable through the lens structure 96. For example, the printed layer 126 may include the array 22 of image elements shown in FIG. 1.

Referring once again to FIG. 2, it can be seen that the periodic array of image elements 14 extend in a first direction indicated by the arrow referenced 54 whilst the array of image elements 14 and 16 extend in a second direction indicated by the arrow referenced 56. Ideally, these directions are both the same, and there is complete “registration” of the array of image elements with the lens elements. However, the process for manufacturing security documents introduces skew between the lens elements and the image elements so that the first and second directions 54 and 56 are different from each other.

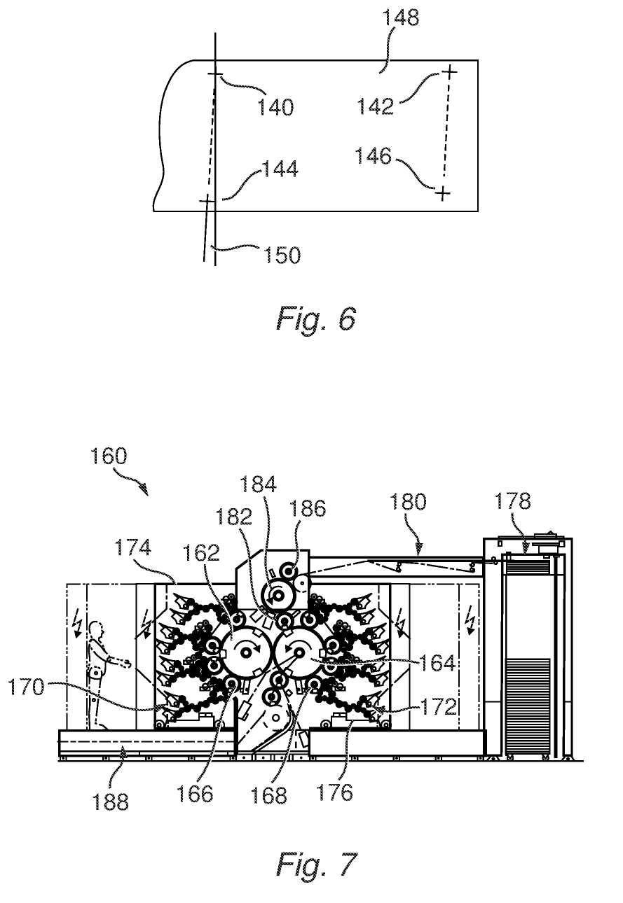

Lens-to-print skew in the final security document is the result of skewing that is applied at various stages of the manufacturing process. The apparatus 80 shown in FIG. 4 introduces a roll-to-roll lens embossing skew, namely an amount of skew introduced into the lens elements during the roll-to-roll process for embossing the lens elements. This is typically the smallest contributor to the final lens-to-print skew. The lens elements are applied to the security substrate 82 with a small amount of skew relative to sheeting reference marks 140 to 146 shown in FIG. 6. The reference marks 140 to 146 are subsequently used to “sheet” the roll or in other words to cut the roll into sheets for subsequent processing. This skew can typically be up to +/−0.2 mm across the width of the web 148 of the security substrate 82 processed by the apparatus 80. For a typical web width of around 800 mm, the roll-to-roll lens embossing skew is typically 0.2/800=0.00025 radians, although it will be appreciated that this is a non-limiting example only.

Sheeting skew makes a further contribution to the total lens-to-print skew in the final security document. Sheeting skew is introduced because the sheets cut from the roll processed by the apparatus 80 are not perfectly square. The sheets are cut with respect to the sheeting reference marks, 140 to 146 applied to the web 148 during the above mentioned roll-to-roll lens embossing process. This skew 150 can typically be plus/minus 0.5 mm across the width of the web 148. For a typical web width of around 800 mm, the sheeting skew can therefore be 0.5/800=0.000625 radians, although it will be again appreciated that this is a non-limiting example only.

Sheets cut from the security substrate web are then fed to an offset press 160 in FIG. 7. The offset press 160 comprises two blanket cylinders (or impression cylinders) 162, 164 rotating in the direction indicated by the arrows and between which the sheets are fed to receive multicolour impressions. The blanket cylinders 162, 164 receive and collect different ink patterns in their respective colours from plate cylinders 166 and 168 (four on each side) which are distributed around a portion of the circumference of the blanket cylinders 162, 164. These plate cylinders 166 and 168, which each carry a corresponding printing plate, are themselves inked by corresponding inking units 170 and 172, respectively. The two groups of inking units 170 and 172 are placed in two inking carriages 174, 176 that can be moved toward or away from the centrally-located plate cylinders 166, 168 and blanket cylinders 162, 164. The plate cylinder 164 is equipped with several engraved printing plates distributed uniformly. The collector inking cylinder 166 has an elastic surface of the same diameter as the plate cylinder 164 and, in this example, like the impression cylinder 162 is equipped with three blankets. Along the periphery of the collector inking cylinder 166 and in contact with this are mounted selective colour inking cylinders 168 each being inked by means of its own inking device 170.

Sheets are fed from a feeding station 178 located next to the printing group (i.e to the right of FIG. 7) onto a feeder table 180 and then to a succession of transfer cylinders 182, 184 and 186 (three cylinders in this example) placed upstream of the blanket cylinders 162, 164.

In the example of FIG. 7, the sheets are transferred onto the surface of blanket cylinder 164 where a leading edge of each sheet is held by appropriate gripper means located in cylinder pits between each segment of the blanket cylinder. Each sheet is thus transported by the blanket cylinder 164 to the printing nip between the blanket cylinders 162 and 164 where simultaneous recto-verso printing occurs. Once printed on both sides, the printed sheets are then transferred as known in the art to a chain gripper system 188 for delivery to a sheet delivery station (not shown) comprising multiple delivery piles.

The ink applied by the offset press 160 results in a printed layer 126 (FIG. 5) being applied to the second surface 110 on the opposite side of the substrate to the first surface 94 in the window area 124. The printed layer 126 forms the periodic array of image elements viewable through the periodic array of lens elements 96.

Contributions to lens-to-print skew in the final security document are made by both the in-feeding of the sheets to the offset press 160, as well as to a print distortion skew applied during application of the ink to the security substrate by the apparatus 160.

The in-feed skew caused by the offset press 160 is the amount of skew introduced as the sheet is fed into the offset press 160. This occurs because a sheet is typically not fed into the printing machine perfectly square. This skew can typically be up to +/−0.3 mm across the width of the sheet. For a typical sheet width of around 800 mm, the in-feed skew is 0.3/800=0.000375 radians although it will be appreciated that this is a non-limiting example.

Finally, printing distortion skew is an amount of skew introduced by the offset press 160 as the sheet is printed. During printing of the array of image elements, the sheet is squeezed between a printing surface, usually the above mentioned blankets with ink being located in the image areas, and another surface (usually the above mentioned impression roller or another blanket that is simultaneously printing ink on an opposite side of the sheet). This applies a non-uniform distribution of strain across the sheet, and a corresponding non-uniform distribution of addition skew across the sheet. This skew can typically be up to +/−0.6 mm across the width of the sheet for a typical sheet width of around 800 mm. The printing distortion skew can therefore to up to 0.6/800 or 0.00075 radians by way of a non-limiting example.

By adding the above mentioned maximum roll-to-roll lens embossing skew, sheeting skew, in-feed skew and printing distortion skew, a total of 0.00025+0.000625+0.000375+0.00075=0.002 radians maximum lens-to-print skew is obtained.

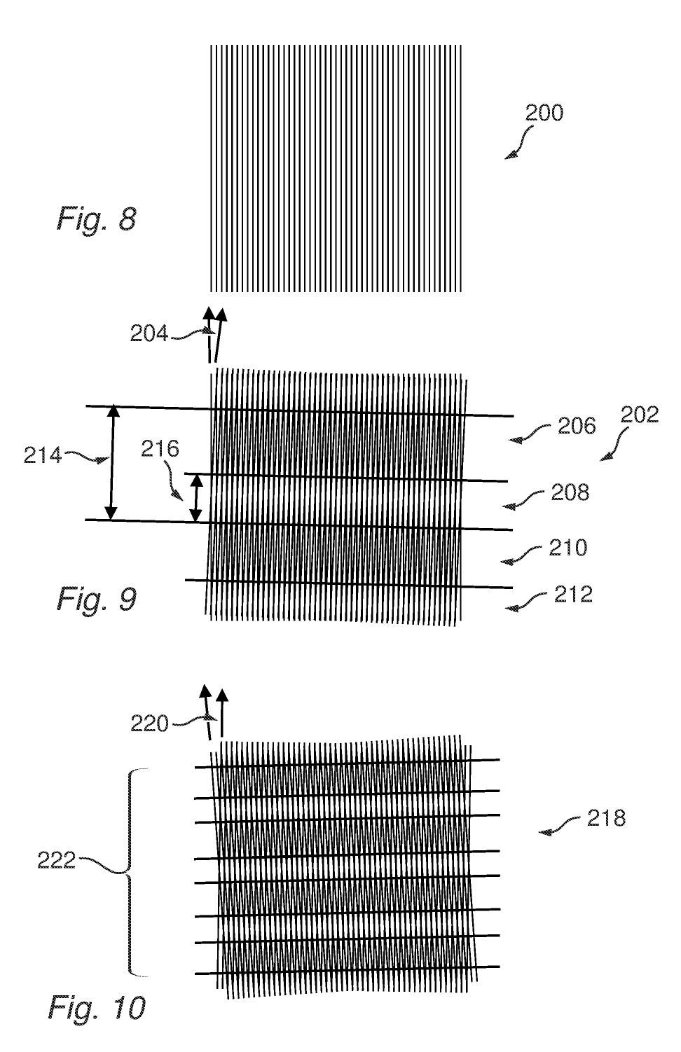

FIG. 8 depicts an optical effect 200 generated in an idealized security device in which a first periodic array of image elements extending in a first direction is applied to one side of a transparent security substrate, whilst a periodic array of lens elements extending in the same direction is applied to the opposite side of the security substrate so as to be superposed with and act to magnify the first periodic array of image elements. In this case, there is no skew between the lens elements and the image elements.

However, a more realistic optical effect 202 is depicted in FIG. 9. During manufacture of a security element there is invariably some small amount of lens-to-print skew introduced which causes a moiré fringe to be visible in a flipping image. The optical effect 202 depicts a basic moiré fringe, caused by the intersection of two set of parallel lines, in this case the first periodic array of image elements which are skewed from the periodic array of lens elements by a skew angle 204. The moiré fringe or pattern depicted in FIG. 9 includes a recurring pattern of alternating light and dark moiré bands 206 to 212. The moiré fringe has a moiré period 214 indicating the period over which the moiré band repeats, and from that moiré period 214 it is also possible derive a moiré half period 216.

The moiré fringe manifests as a “rolling band” across a security element under certain circumstances, that is, when the banknote is tilted the user sees a gradual transition from one image to the other (in the case of flipping lenticular images) as the moiré fringe moves across the image area. The greater the degree of skew, the smaller the period of the moiré fringe and the more slowly the moiré fringes move as the banknote is tilted. This is depicted in FIG. 10 which shows the optical effect 218 produced when the skew angle 220 between the parallel image elements and the parallel lens elements is increased from the skew angle 204 shown in FIG. 9 to the skew angle 220 shown in FIG. 10. It can be seen from FIG. 10 that increasing the skew angle results in moiré bands 222 that have a narrower width and a shorter period and half period than the corresponding moiré bands, period and half period depicted in FIG. 9.

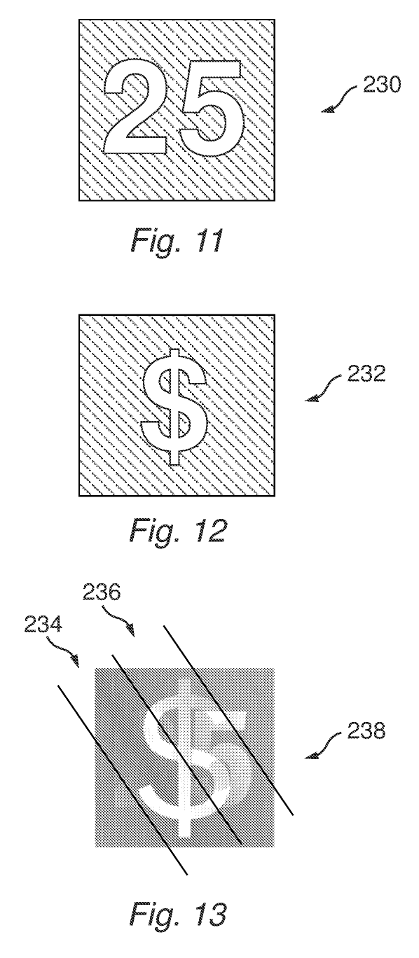

FIGS. 11 and 12 depict respectively two frames of “flipping” image frames 230 and 232 of a flipping image for use, in this exemplary embodiment, in the security device depicted in FIG. 1 forming part of the security document manufactured in the manner described in relation to FIGS. 4 to 7. As has been explained in relation to FIGS. 1 and 2, each of these images consist of a series of parallel image elements that are interlaced together and printed on one side of the substrate 16 shown in FIG. 1. A lenticular lens is located on the opposite side of the substrate. At a first viewing angle, the image 230 is viewed, whereas at another viewing angle the image 232 is viewed. If a skew is introduced between the array of image elements and the array of lens elements, moiré fringes can result, such as the moiré bands 234 and 236 shown in the optical effect 238 generated by the security device depicted in FIG. 13. In this optical effect, rather than a “hard” flip between the two images 230 and 232 shown in FIGS. 11 and 12 as the device is tilted, a diagonal moiré band rolls across the viewed image revealing one image in the moiré band 324 and the other image being viewable outside that moiré band.

It is desirable to show only one image at a particular viewing angle (except at a transition viewing angle where both images can be seen simultaneously as very faint images). Ideally, there should be no moiré fringes in the optical effect generated by the security elements, regardless of the viewing angle. However, as mentioned above, a skew is invariably introduced during the manufacturing process of security documents, the greater the skew between the imagery and the lenses, the smaller or thinner the moiré bands.

In order to address this issue of moiré fringes transitioning across the security element, the security document can be manufactured by performing a series of steps that act to limit the design area or extent of the array of image elements and/or the array of lens elements or other revealing elements. These steps include firstly determining one or more characteristics or moiré bands that would be or are observed to transition across the image elements during movement of the security document relative to an observer between, at least, a first viewing angle and a second viewing angle as a result of the revealing elements and image elements extending in different directions.

Secondly, at least one of the dimensions, such as the height or width, of the first periodic array of image elements and/or the periodic array of revealing elements is constrained to be smaller than the width of at least one of the moiré bands. In order to minimise the issue of moiré fringes transitioning across the security element, it is preferable that all of the dimensions of the first periodic array of image elements and/or the periodic array of revealing elements are constrained to be smaller than the width of at least one, and preferably the smallest, of the moiré bands.

Finally, the array of image elements and the array of lens elements, constrained as set out above, are manufactured as part of the security document.

In other words, once one or more characteristics of the moiré bands are known, either from a pre-production trial run or from estimation of the maximum skew likely to be introduced during manufacture of the security document, the moiré band width of the moiré bands introduced by such a skew can be derived. Once the minimum moiré band width is known, then at least one dimension and preferably the maximum design area or extent of the array of image elements and/or the array of lens or other revealing elements can be set to be smaller than that minimum band width so that moiré bands will not be present to a viewer in the final manufactured security document.

It will be appreciated that the design area of the security image in question in the union of the area of the first image elements when interlaced with the second image elements.

According to a first embodiment, the one or more characteristics of moiré bands can be determined by manufacturing a calibration security document including a second periodic array of revealing elements and a second periodic array of image elements, the second periodic array of revealing elements and the second periodic array of image elements being identical to the first periodic array of image elements and the second periodic array of image elements except that they extend over a sufficient area to enable moiré bands to be observed to transition across the image elements during the movement of the security document; and measuring the one or more characteristics of the observed moiré bands.

In other words, there is no attempt to initially constrain the display area or one or more dimensions of the security image. In one or more embodiments, a periodic array of image elements that is coextensive or occupies the same display areas, and is superposed with, the periodic array of lens elements is manufactured. One or more characteristics of moiré bands that are observed to transition across the magnified image elements are then measured from this calibration security document.

In one exemplary embodiment, a representative sample of a two-flip lenticular image is printed on the reverse side of representative substrates with lenses, using a simple design such as a rectangle that spans the entire area of the lenses and which is designed to “switch on” and “switch off” as the manufactured security document such as a banknote is tilted. After passing through the manufacturing process described in relations to FIGS. 4 to 7, the finished samples are then analysed to determine the maximum design area or maximum extent of at least one dimension of the two-channel flipping image corresponding to the area spanned by the smallest moiré fringe, in this case the width of at least one, preferably the smallest, dark band in the moiré band. The smallest moiré band has a repeating period and is inclined at a certain angle or skew. The maximum two-flip design area will span one half of the smallest moiré period, and will be inclined at a certain skew angle. An example using this approach is described below.

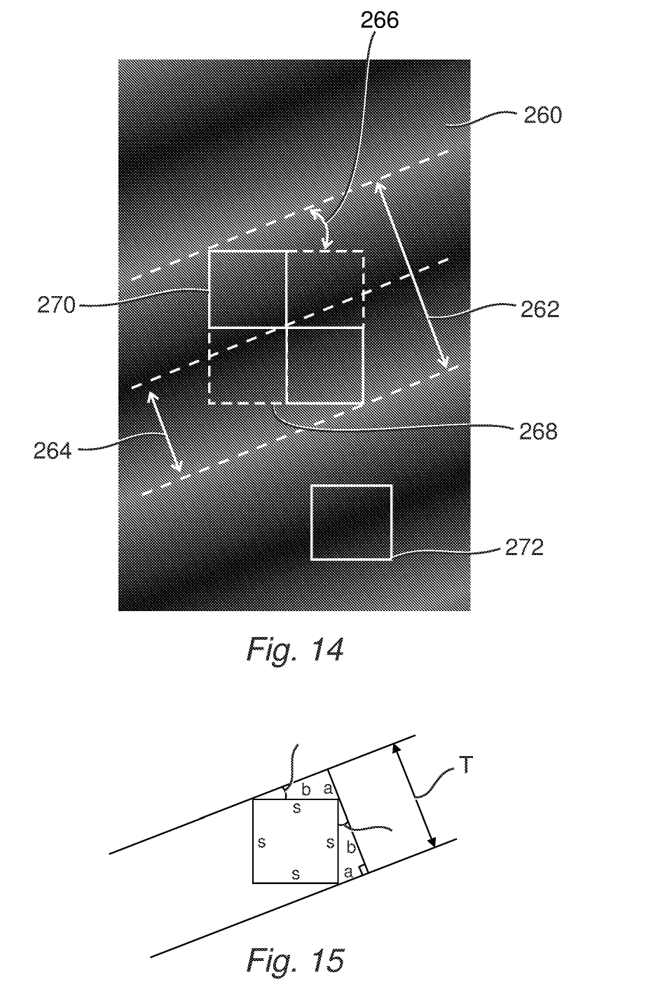

As seen in FIG. 14, a rectangular area 260, having a size such that the area is coextensive with the superposed array of lens elements—in this case the area has a size of 27 mm by 42 mm—consisting of parallel lines of pitch equal to the pitch of the array of lens elements, is printed on the opposite size of the security substrate to the lens elements. At the time of printing, there exists a skew between the array of image elements and array of lens elements, which produces moiré bands (if the skew was sufficiently small however, there would be no moiré bands visible). In FIG. 14, the period of the moiré fringes is indicated by the double headed arrow 262 and the half period indicated by the double headed arrow 264. The skew angle of the moiré fringes is indicated by the double headed arrow 266. One exemplary method for determining the maximum design area for the security image is to select a square that fits within half of one period of the moiré pattern. This can be achieved by first selecting a square that fits in the full moiré period, such as a large square referenced 268 in FIG. 14.

This large square can then be divided into four equal sized smaller squares, such as the square referenced 270. These smaller squares will then fit precisely within half of one period of the moiré pattern.

It will be appreciated that the smaller the size of the square chosen to define the maximum security image design area, the cleaner the “flip” will be because less of the moiré fringes will be visible in the flipping image design. Conversely, as the square size increases, more of the moiré fringes will be visible in the flipping image design. By setting the design area of the flipping image to correspond to the size of the square referenced 270 in FIG. 15, the visibility of the moiré fringes in the final design will be greatly reduced.

The intensity profile of the moiré fringes, perpendicular to their axis is sinusoidal. The intensity values within the area of the square referenced 272, when the dark part of the fringe is cantered in the middle of the blue square, is on average strongly positive (dark), which means that the visibility of the moiré fringes will be very low. This is desirable in order to achieve a clean two-flip image.

The geometric relationship between the size of the large square 268 and small square 272, as well as the angle and period of the moiré fringes is derived from the equations below, when are to be read in relation to the geometric arrangement depicted in FIG. 14.

T=a+b=_{+S×cos θ}^{S×sin θ}

sin θ=a/s

cos θ=b/s

In the example depicted in FIG. 14, the moiré period is measured from the printed sample and found to be approximately 16 mm, whilst the moiré angle is also measured and found to be approximately 21 degrees. Using the above mentioned equations, the size of the larger square 268 is calculated to be

16/(Sine(21)+Cosine(21))=12 mm. In other words, the design area of the array of image elements would not be bigger that 0.5×12=6 mm×6 mm square in order to minimise the visibility of moiré fringes in the final design of the security document.

Another approach to determining one or more characteristics or moiré bands is to determine a maximum skew between the first periodic array of image elements and a periodic array of lens elements by one or more manufacturing steps during manufacture of the first security document, and then to derive the one of more characteristics or moiré bands from the maximum skew.

It will be appreciated the one or more characterises or moiré bands may include the moiré period or other value representative of the width of the smallest moiré bands, as well as the moiré angle characterising the angular offset of the moiré bands from the first direction.

Accordingly, the maximum lens-to-print skew can be determined and then this information used, together with the frequency of the array of lens elements and the frequency of the array of image elements that make up the two-flip image in this exemplary embodiment, to calculate the corresponding period and angle of the moiré fringes. The maximum design area of the two-flip lenticular image will again correspond to one half of one moiré period and will be inclined at a calculated angle. An exemplary skew component introduced by a series of manufacturing steps was described in relation to FIGS. 4 to 7. In that example, the total lens-to-print skew introduced by those processes was a maximum of 0.002 radians.

In an exemplary embodiment, the lens period may be 400 lens elements per inch and the flipping imagery pitch may be 400 lines per inch.

These values can then be used in the following equation (reference: Isaac Amidror, “The Theory of the Moire Phenomenon” (2000, Vol. 15 Computational Imaging and Vision, ISBN 0-7923-5950-X) in order to calculate the angle of the resulting moiré:

$${α}_{m} = arc tan ( \frac{{T}_{b} \cdot sin {α}_{r} - {T}_{r} sin {α}_{b}}{{T}_{b} \cdot cos {α}_{r} - {T}_{r} \cdot cos {α}_{b}} )$$

wherein T_{b}=Tᵣ=400, αᵣ=0.002 radians, α_{b}=0 radians
This results in a moiré angle=αₘ=90.057 degrees (relative to vertical)
The above values can then be used in the following equation (reference: Isaac Amidror, “The Theory of the Moire Phenomenon) in order to calculate the period of the resulting moiré:

$${T}_{m} = \frac{{T}_{b} \cdot {T}_{r}}{{T}_{b} \cdot cos {α}_{r} - {T}_{r} \cdot cos {α}_{b}} \cdot cos {α}_{m}$$

wherein T_{b}=Tᵣ=400, αᵣ=0.002 radians, α_{b}=0 radians, αₘ=90.057 degrees
This results in a moiré period=Tₘ=32 mm

The size of the maximum design area for the security image element (corresponding to the smaller square 270/272 shown in FIG. 14) can then be computed from earlier calculations. The calculated sizes of the smaller square 270/272 and the larger square 268 are then determined to be as follows:

Larger square size 266=32/(Sin(90−90.057)+Cos(90−90.057))=32 mm

Smaller square size 268=0.5*32=16 mm=max design size for minimised fringes visibility

The Applicant has found from exemplary trials that typical maximum design areas for a two-slip imagery for a banknote substrate sheet with 400 LPI lenses is 10 mm×10 mm. By constraining the two-flip design image to fit within this areas, clean two-flip switching image effects are consistently realized across the sheet or in other words in every banknote location. The security device 10 depicted in FIGS. 1 and 2 includes a periodic array 12 of lens elements 14 forming a lenticular lens for viewing a first image from a first viewing angle and a second image from a second viewing angle. In this embodiment, the groups of image elements 24 comprise a first image channel and the group of image elements 26 form a second image channel. The first image channel is viewed via the lenticular lens from the first viewing angle and the second image channel is viewed via the lenticular lens from the second viewing angle.

In other embodiments of the invention though, image elements from either the first or the second image channel may be absent. In such embodiments, the image elements from the first or second image channel will be viewable from one of the first or second viewing angles, but no image elements would be viewed from the other viewing angle. Rather than flipping from one image to another image, when the security document is moved relative to an observer between the two viewing angles, the image channel containing image elements is either revealed or disappears.

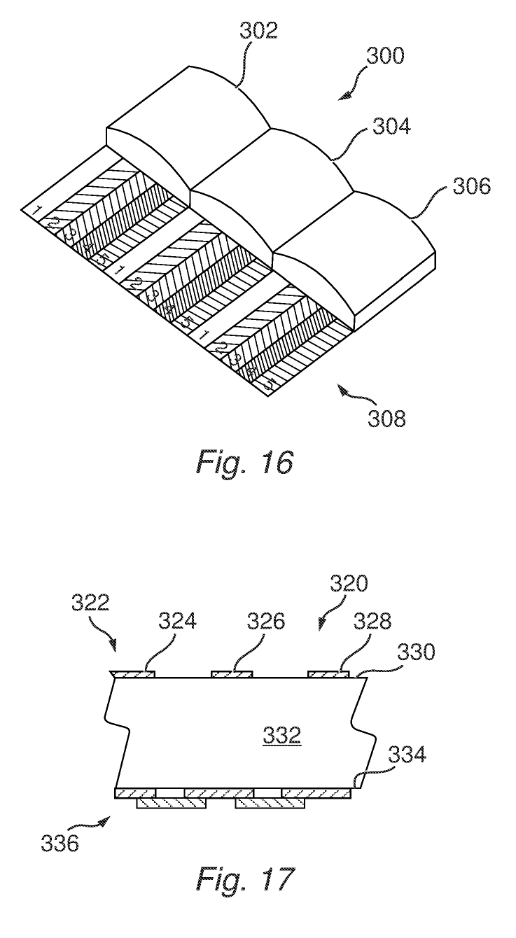

The present invention is also applicable to security documents including security devices producing optical variable effects other than the above-described flipping effect and to security devices having more than two image channels. By way of example, FIG. 16 depicts in a schematic manner an array 300 of lens elements 302 to 306 superposed with a periodic array 308 of image elements. In this example, the periodic array 308 includes 5 groups of interleaved image elements, each forming a separate image viewable in a separate image channel. Image elements from the first through to the fifth image channel are respectively labelled “1” through to “5”. As the security document is moved relative to an observer, from a first, through a second, third and fourth and onto a fifth viewing angle, five image channels are viewed in succession by an observer. The optical variable effect produced by that succession of observable image channels is known as an animation effect.

The present invention is also applicable to the manufacture of a security document including a multi-image channel security device as depicted in FIG. 16.

Furthermore, the above described embodiments include security devices where the periodic array of image elements applied to one surface of the substrate of the security and document are revealed by a periodic array of lens elements applied to the opposing side of the substrate so as to magnify and reveal the image elements. However, it should be appreciated that the periodic array of lens elements in these embodiments is merely one example of a periodic array of revealing elements that can be applied to such security devices.

For example, revealing elements—such as a set of parallel lines—can also be applied. Such an alternative arrangement is depicted in FIG. 17, which shows a security device 320 forming part of a banknote or other security document. The security device 320 includes a periodic array 322 of parallel lines 324 to 328 applied to an upper surface 330 of a transparent substrate 332. As is the case in the security 10 depicted in FIG. 1, the lower surface 334 of the substrate 332 is an object plane carrying a periodic array 336 of image elements.

Such an arrangement enables a similar range of optical variable effects to be produced as is the case with the embodiments described in relation in FIGS. 1 to 16, namely flipping or animation effects. The lines 324 to 328 have the same effect as the lens elements 14 in that they also effectively sample the array of image elements 336. In the embodiment depicted in FIG. 17, the resulting image viewed by an observer is produced with a lower contrast compared to that achieved with lens elements. The lines repeat with the same pitch as the lens elements. The width of each line, and the corresponding gap in between, will determine the contrast apparent to the observer. The wider these lines, the smaller is the gap, the finer is the width of the image that is sampled and the lower is the resulting image contrast.

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereof.

It will be understood that the invention is not limited to the specific embodiments described herein, which are provided by way of example only. The scope of the invention is as defined by the claims appended hereto.

1. A method of manufacturing a first security document, the security document including:
a transparent substrate;
a first periodic array of image elements applied to a first surface of the substrate and extending in a first direction; and
a first periodic array of revealing elements applied to an opposing surface of the substrate and extending in a second direction, the first periodic array of revealing elements being superposed with the first periodic array of image elements, such that an optical variable effect can be observed between at least a first viewing angle and a second viewing angle, the method including the steps of:
a. determining one or more characteristics of moiré bands that would be or are observed to transition across the first periodic array of image elements during movement of the security document relative to an observer between, at least, the first viewing angle and the second viewing angle as a result of the first direction being different from the second direction;
b. constraining at least one dimension of the first periodic array of image elements and/or the first periodic array of revealing elements to be smaller than the width of at least one of the moiré bands; and
c. causing the first periodic array of image elements and the first periodic array of revealing elements, constrained as set out in step(b), to be manufactured as part of the security document.

2. A method according to claim 1, wherein the one or more characteristics of moiré bands are determined in step a. by:
manufacturing a calibration security document including a second periodic array of revealing elements and a second periodic array of image elements, the second periodic array of revealing elements and the second periodic array of image elements being identical to the first periodic array of image elements and the second periodic array of image elements except that they extend over a sufficient area to enable moiré bands to be observed to transition across the image elements during the movement of the security document; and
measuring the one or more characteristics of the observed moiré bands.

3. A method according to claim 1, wherein the one or more characteristics of moiré bands are determined in step a. by:
determining a maximum skew between the first periodic array of image elements and the first periodic array of revealing elements that may be introduced by one or more manufacturing steps during manufacture of the first security document; and
deriving the one or more characteristics of moiré bands from the maximum skew.

4. A method according to claim 2, wherein the one or more characteristics of moiré bands include any one or more of:
the moiré period or other value representative of the width of the smallest moiré bands; and
the moiré angle characterising the angular offset of the moiré bands from the first direction.

5. A method according claim 1, wherein
the periodic array of revealing elements reveals a first image channel from the first viewing angle and a second image channel from the second viewing angle; and
the or each periodic array of image elements includes a first group of image elements forming a first image viewable in the first image channel.

6. A method according to claim 5, wherein
the or each periodic array of image elements further includes a second group of image elements forming a second image viewable in the second image channel.

7. A method according to claim 5, wherein
the first periodic array of revealing elements reveals a third image channel from a third viewing angle; and
the or each periodic array of image elements includes a third group of image elements forming a third image viewable in the third image channel.

8. A method according to claim 1, wherein
the revealing elements are lens elements that act to magnify the image elements.

9. A method according to claim 1, wherein
the revealing elements are lines.
